(19) United States
(12) Patent Application Publication
(10) Pub. No.: US 2008/0264156 A1
(43) Pub. Date: Oct. 30, 2008

(54) PROCEDURE FOR DIAGNOSING A FUEL TANK VENTILATION SYSTEM OF A VEHICLE AND DEVICE FOR IMPLEMENTING THE PROCEDURE

(75) Inventors: Martin Streib, Vaihingen (DE); Andreas Pape, Oberriexingen (DE); Andreas Baumann, Farmington Hills, MI (US)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/105,873

(22) Filed: Apr. 18, 2008

(30) Foreign Application Priority Data
Apr. 18, 2007 (DE) 10 2007 018 232.7

(51) Int. Cl. G01M 15/09

(52) U.S. Cl. 73/114.43

(57) ABSTRACT

A procedure for diagnosing a tank system of a vehicle with at least two controllable tank ventilation valves, with at least two points of release for a tank ventilation mixture, whereby at least a first point of release runs into an inlet manifold of a combustion engine downstream of a throttle device and at least a second point of release is arranged in an inlet manifold of the combustion engine upstream of the throttle device, especially upstream of a compressor, is thereby characterized, in that for diagnosing the functionality of the tank ventilation system the at least two tank ventilation valves are controlled independently of each other and its functionality can be implied due to the pressure that occurs in the tank system.

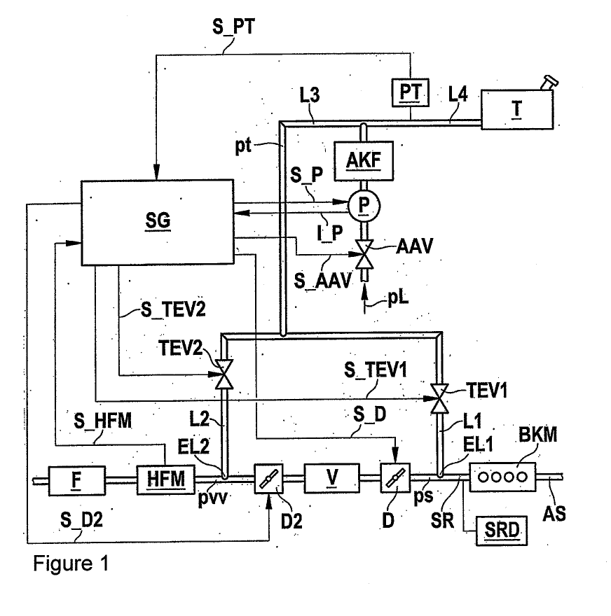

### TECHNICAL FIELD

The invention is based on a procedure for diagnosing a fuel tank ventilation system of a motor vehicle with at least two controllable tank ventilation valves and a device for implementing the procedure according to the category of the independent claims.

Subject matter of the present invention is also a computer program as well as a computer program product with a program code, which is saved on a machine-readable medium, for implementing the procedure.

A fuel tank ventilation system for a combustion engine of a motor vehicle originates from DE 43 42 431 A1, at which statements about the condition of the tank ventilation system are deduced from the result of pressure measurements in the tank system.

### BACKGROUND

DE 196 48 711 A1 reveals a procedure for determining the flow rate through a tank ventilation valve of a tank ventilation system, at which the difference of pressures that occur at the tank ventilation valve are determined and at which the fuel vapor volume that flows through the tank ventilation valve is implied from the difference.

The pre-published DE 10 2006 016 339 describes a procedure and a device for diagnosing a fuel tank ventilation system of a vehicle with at least two ventilation paths that run into the exhaust area of a combustion engine. A first ventilation path runs into the exhaust area of the combustion engine downstream of a compressor and a second ventilation path runs upstream before the compressor into the exhaust area of the combustion engine. The diagnosis provides for at least two partial diagnoses, whereby the first partial diagnosis is carried out relating to the first ventilation path, if the inlet manifold pressure is lower in the orifice area of the first ventilation path than the tank system pressure, and the second partial diagnosis is carried out relating to the second ventilation path, if the inlet manifold pressure in the orifice area of the first ventilation path is higher than the tank system pressure. An error signal is provided, if at least one of the partial diagnoses produces a partial error signal.

Due to this procedure an almost complete diagnosis of a tank ventilation system with at least two points of release in the exhaust area of the combustion engine is possible. An on-board diagnosis provides at least one error signal depending on the diagnose result and signalizes thereby an error in the partial ventilation system, which can emission relevant.

Preferably two tank ventilation valves are deployed for charged engines. The established procedures and devices for diagnosing the functionality of the tank ventilation valves however do not provide a possibility for diagnosing both tank ventilation valves.

### SUMMARY

According to the invention the procedure with the characteristics of the independent procedure claims presents the advantage of a complete diagnosis of the tank ventilation system, especially a diagnosis of both tank ventilation valves as well. Thereby an on-board diagnosis, which is mandatory in many countries, e.g. California, is possible. Within the scope of this on-board diagnosis an error signal depending on the diagnose result is provided and an error in the tank ventilation system is signalized, which can be emission relevant. For this purpose the at least two tank ventilation valves are controlled independently of each other for diagnosing the functionality of the tank ventilation system and their function as well as the function of the entire tank system is implied due to the pressure that occurs hereby in the tank system.

Due to the measures that are specified in the dependent claims advantageous improvements and embodiments of the procedure according to the invention are possible.

Thus the stream of gas is preferably directed to the first point of release by use of the first tank ventilation valve and by use of the second tank ventilation valve to the second point of release.

In addition to both tank ventilation valves advantageously a controllable stop valve is provided, which controls the ventilation of the tank.

An advantageous embodiment of the procedure provides that a dimension for the pressure in the tank system is determined for checking the functionality of the tank system, and that due to this pressure the tightness of the tank system is implied.

The functionality of the second point of release can be thereby determined, in that it is checked, whether the tank descents when opening the second tank ventilation valve. For this purpose the second tank ventilation valve is openingly controlled while the first tank ventilation valve is closingly controlled in an operating status of the combustion engine, in which in the suction system in the ambit of the second point of release a pressure is present that is reduced compared to the pressure in the tank system. If the pressure in the tank system drops in this case, the path between the tank system and the second point of release is assumed to be permeable.

In a similar way the detection of a leaky second tank ventilation valve is possible, if a low pressure occurs in the tank during charge mode at closed tank ventilation valves. For this purpose both tank ventilation valves are closingly controlled in an operating status of the combustion engine, at which in the suction system in the ambit of the second point of release a pressure occurs that is reduced compared to the pressure in the tank system and in the ambit of the first point of release a pressure occurs that is increased compared to the pressure in the tank system, and a leakiness of the second tank ventilation valve is assumed, if a drop of the pressure in the tank system is then recognized, when the controllable stop valve is switched from a opened to a closed status.

Preferably a checking of the second point of release, in other words the point of release upstream of the metering valve device, especially upstream of a compressor, e.g. a turbo charger, takes place in an operating status of the combustion engine with a high air mass flow rate.

Furthermore it is preferably provided that for implementing this diagnosis the pressure is reduced in the ambit of the second point of release, whereby the reducing of the pressure is preferably caused by an additional, controllable flow control device. This flow control device can be realized for example by a throttle valve, which is arranged before the compressor.

In another embodiment of the procedure the second tank ventilation valve is closingly controlled, openingly at a closingly controlled first tank ventilation valve in an operating status of the combustion engine, at which a pressure occurs in the inlet manifold in the ambit of the first point of release that is reduced compared to the pressure in the tank system. In this case the path between the tank system and the first point of release is realized as permeable, in other words regarding the outlet as functional, if the pressure drops in the tank system.

In another embodiment of the procedure in the operating status, in which in the inlet manifold in the ambit of the first point of release a pressure occurs that is reduced compared to the pressure in the tank system, a closing controlling of both tank ventilation valves is undertaken, the stop valve is closingly controlled and in this case a leakiness of the first tank ventilation valve is assumed, if the pressure in the tank drops.

A diagnosis is also possible by producing an overpressure in the tank system. In this case an overpressure is produced in the tank first, preferably by use of an electric pump. After the reduction of the overpressure the second tank ventilation valve is openingly controlled and a path between the tank system and the second point of release is realized as permeable, if at least one or several of the following criteria are satisfied:
the pressure of the tank system drops
a change of the mixture composition in the exhaust gas system is established
a changed torque or a changed engine speed of the combustion engine is established
a reaction of the idle regulator of the combustion engine is established.

An error in the path between the tank system and the second point of release is established in this case, if one or several criteria is/are satisfied.

The device according to the invention for implementing the procedure concerns a controller, which is customized for implementing the procedure.

The controller contains preferably at least one electric memory, in which the steps of the procedure are stored as a computer program.

The computer program according to the invention provides that all steps of the procedure according to the invention are performed, if it runs on a computer.

### BRIEF DESCRIPTION OF THE DRAWING

Further advantageous improvements and embodiments of the procedure according to the invention arise from further dependent claims of the procedure.

Embodiments of the invention are shown in the drawing and explained in the in the following description.

The FIGURE schematically shows a technical environment, in which the procedure according to the invention is running.

### DETAILED DESCRIPTION

The FIGURE shows a combustion engine BKM, in whose exhaust area SR a inlet manifold pressure sensor SRD, a throttle D, a compressor V, a hot-film air-mass sensor HFM and an air filter F are arranged.

The air mass flow that is detected by the hot-film air-mass sensor HFM is brought to a controller SG as a signal S_HFM.

Two points of release for a tank ventilation mixture are provided. A first point of release EL1, which runs into the inlet manifold SR downstream of the throttle D, or the throttle valve, and at least a second point of release EL2, which runs into the inlet manifold SR upstream of the throttle D and especially also upstream of the compressor V. the points of release EL1 and EL2 are connected to the tank system by two pathways L1 and L2, which are each closable by the tank ventilation valves TEV1 and TEV2.

Both tank ventilation valves TEV1 and TEV2 are controllable by the controller by use of control signals S₁₃ TEV1, S_TEV2. Both pathways L1 and L2 run into a joint pathway L3, which is connected to the ambit by an activated carbon filter AKF, a pump P as well as a stop valve AAV that is controllable by a signal S_AAV. Over a pathway L4 the activated carbon filter AKF is connected to a tank T. The hydrocarbons, which are formed due to evaporations in the tank T, are absorbed into the activated carbon filter AKF. For regenerating the activated carbon filter AKF the tank ventilation valves TEV1, TEV2 are opened, so that a low pressure emerges in the pathway system L1, L2, L3, which is required for regenerating the activated carbon filter AKF. In this case the stop valve AAV is closingly controlled by a corresponding control signal S_AAV, so that the system is closed.

The pump P can also be controlled by the controller by use of a control signal S_P. The pump P serves the production of an overpressure in the tank system, which is required for checking the thickness.

The procedure according to the invention for diagnosing such a tank system of a vehicle with at least two controllable tank ventilation valves TEV1 and TEV2 is described in the following.

The tank system supplies the combustion engine BKM with fuel. The combustion engine BKM can be operated in at least two different operating statuses, whereby a first operating status corresponds with a suction mode and a second operating status with a charge mode of the combustion engine BKM.

The charge mode of the combustion engine BKM is achieved with the compressor V, which is for example the compressor of a turbo charger system or for example the compressor of an electrically or mechanically operated pump or compressor. The separation into two ventilation paths L1 and L2 allows a ventilation of the tank system during a long lasting charge mode of the combustion engine BKM, at which a first inlet manifold pressure ps is higher in the first point of release EL1 than the tank system pressure, whereby the first tank ventilation valve TEV1 is closed in this case.

In this condition a ventilation possibility principally exists by the openingly controlled tank ventilation valve TEV2 over the pathway L2, which is especially also given, because, due to the generally increased air flow rate in the suction area during the charge mode of the combustion engine BKM, a pressure drop especially at the air filter F can be assumed, which arranges it so that a second suction pressure pvv is lower than the tank system pressure. In this case the second tank ventilation valve TEV2—as mentioned—is openingly controlled.

The subsequently described diagnosis of the tank system takes place by use of a pressure measurement, whereby the pressure pt in the tank system is detected by a pressure sensor PT, whose output signal S_PT is brought to the controller SG.

It shall be understood that the invention is not limited to the detection of the pressure by use of a pressure sensor PT, but rather the pressure can also be detected by other means, as for example by modeling other measured factors or for example by inserting a low- or overpressure by use of a pump P and measuring the pump stream, which is a dimension for the pressure.

The detection of a clear second point of release EL2 provides that the second tank ventilation valve TEV2 is openingly controlled while the first tank ventilation valve TEV1 is closingly controlled in an operating status of the combustion engine BKM, in whose suction part in the ambit of the second point of release EL2 a pressure occurs that is reduced compared to the pressure in the tank system. In this case, if the pressure drops in the tank system, which is detected by the pressure sensor PT, the path between the tank system and the second point of release EL2, in other words pathway L2 and L3, is assumed to be permeable.

A leaky second tank ventilation valve TEV2 can be detected in the following way:

In an operating status of the combustion engine BKM, in whose suction system in the ambit of the second point of release EL2 a pressure occurs that is reduced compared to the pressure pt in the tank system, in other words pvv is lower than the pressure in the tank system pt, and in the ambit of the first point of release EL1 a pressure occurs that is higher compared to the pressure pt in the tank system, in other words ps is higher than pt, both tank ventilation valves TEV1 and TEV2 are closingly controlled and a leakiness of the second tank ventilation valve TEV2 can be assumed, if a drop of the pressure pt takes place in the tank system and it is detected, when the controllable stop valve AAV is switched from opened to closed.

The pre-mentioned checks preferably take place in an operating status with a high air mass flow rate of the combustion engine BKM, which is determined by use of a hot-film air flow meter HFM.

The reduction of the pressure in the ambit of the second point of release EL2 can also be provided by a second throttle device D2, which is controllable by the controller SG over a control signal S_D2.

The detection of a permeable second path, in which the tank ventilation valve TEV1 is arranged, in other words pathway L1 and L3, takes place during an operation at partial load of the combustion engine BKM. In this operating status, in which in the inlet manifold SR in the ambit of the first point of release EL1 a pressure occurs that is reduced compared to the pressure pt in the tank system, in other words ps<pt, the second tank ventilation valve TEV2 is openingly controlled while the first tank ventilation valve TEV1 is closingly controlled. If in this case the pressure in the tank system drops, in others words pt decreases, the first point of release EL1 is assumed to be permeable.

A leaky first tank ventilation valve TEV1 can be thereby detected, in that in the operating status, at which in the inlet manifold in the ambit of the first point of release EL1, a pressure occurs that is reduced compared to the pressure pt to the tank system, which is the case for example during operating at partial load, both tank ventilation valves TEV1, TEV2 as well as the activated carbon filter-stop valve AAV are closingly controlled. A leakiness of the first tank ventilation valve TEV1 can be assumed in this case, if the pressure in the tank pt drops, which is detected by processing the pressure signal S_PT in the controller.

A checking is also possible by producing an overpressure. In this case the pump P is controlled by a corresponding control signal S_P, which is produced by the controller, so that an overpressure is produced in the tank system. After the overpressure has been built up, which can be again detected by use of the pressure sensor PT, or also by detecting the current for the engine of the overpressure pump P, the second tank ventilation valve TEV2 is opened. In this case the path between the tank system and the second point of release EL2 is detected as permeable, if at least one of the following criteria is satisfied:
the pressure pt in the tank system drops;
a change of the mixture composition in the exhaust gas system AS of the combustion engine BKM is detected;
a changed turning moment or a changed rotational speed of the combustion engine is detected;
a reaction of the idle regulator of the combustion engine is detected.

An error in the path between the tank system and the second point of release EL2 is detected, if one or several of the mentioned criteria are satisfied.

A permeable second path, in other words a permeable pathway system L2, L3 of the second point of release EL2 is detected, if by use of the pump P a low pressure is produced in the tank system and after the reduction of the low pressure the second tank ventilation valve TE2 is opened. If in this case the pressure in the tank system pt increases, the permeable second point of release EL2 is closed.

Besides the previously described function check-outs a lambda deviation in the exhaust gas can also be used for checking the functionality of both tank ventilation valves TEV1 and TEV2. This takes place in an operating status, in which the tank pressure is higher than the inlet manifold pressure. This way for example the first point of release can be detected as functional, in other words permeable, if a change of the air ratio lambda towards rich or lean occurs while the first tank ventilation valve TEV1 is opened.

In a corresponding way the diagnosis of the second tank ventilation valve TEV2 can be undertaken, if at an opened tank ventilation valve TEV1 a change of the air ratio lambda towards rich occurs and after opening the tank ventilation valve TEV2 the lambda ratio changes partially or completely towards the value 1. In this case the second point of release EL2 is implied to be permeable.

As previously mentioned, the pressure can be either detected by use of the pressure sensor PT and/or by use of the pump P itself. In this case the no-load current of the pump is detected. The pump is thereby quasi calibrated, if the pressure in tank system pt equals the ambit pressure pL. In this case the no-load current of the pump P is detected and recorded. Thereby a factor that characterizes the pump P, for example the pump current I_P, is recorded. Alternatively the engine speed can also be saved or recorded in the controller SG.

A leakage can be thereby detected, in that the pump pumps against a not shown reference leak and the pump current I_L in the tank system is compared to the current that has been recorded by pumping against the reference leak.

1. A method of diagnosing a tank system of a vehicle having a plurality of controllable tank ventilation valves with at least two points of release for a tank ventilation mixture, whereby at least one point of release leads to a suction tube of a combustion engine positioned downstream of a throttle device and at least one point of release is arranged in a suction tube of the combustion engine positioned upstream of the throttle device, the at least one point of release positioned upstream of the throttle device positioned especially upstream of a compressor, the method comprising:
controlling the plurality of ventilation valves, wherein the plurality of ventilation valves are independently controlled; and
deriving a functionality of a tank ventilation system, wherein the functionality is implied from a pressure that occurs in the tank system.

2. A method according to claim 1, further comprising steering a stream of a gas to a first point of release by use of a first tank ventilation valve and to a second point of release by use of a second ventilation valve.

3. A method according to claim 1, further comprising controlling the ventilation of a tank with a controllable stop valve.

4. A method according to claim 1, further comprising openingly controlling a first tank ventilation valve simultaneously with closingly controlling a second tank ventilation valve, wherein the combustion engine operating status is such that in an inlet manifold in an ambit of a second point of release a pressure occurs that is reduced compared to the pressure in the tank system, whereby when the pressure in the tank system drops, a path between the tank system and the second point of release is assumed to be permeable.

5. A method according to claim 4, wherein the combustion engine operating status is such that in the inlet manifold in the ambit of a second point of release a pressure occurs that is reduced compared to the pressure in the tank system and in an ambit of a first point of release a pressure occurs that is increased compared to the pressure in the tank system, wherein the second tank ventilation valve and the first tank ventilation valve are closingly controlled and a leakiness of the second tank ventilation valve can be implied if a decrease of the pressure in the tank system is realized when a controllable stop valve is switched from an opened to a closed status.

6. A method according to claim 5, wherein an implication of the permeability and of the leakiness of the second tank ventilation valve occurs under a high air mass flow rate operating status of the combustion engine.

7. A method according to claim 5, wherein the pressure in the ambit of the second point of release is reduced by use of an additional controllable throttle device.

8. A method according to claim 1, wherein a combustion engine operating status is such that in an inlet manifold in an ambit of the first point of release a pressure occurs that is reduced compared to a pressure in the tank system, wherein a second tank ventilation valve and a first tank ventilation valve and a stop valve are closingly controlled and a leakiness of the first tank ventilation valve is recognized if the pressure in the tank drops.

9. A method according to claim 1, further comprising producing an overpressure in a tank, preferably via an electric pump, and in that after the buildup of the overpressure, a second tank ventilation valve is openingly controlled and a path between the tank system and a second point of release is recognized as permeable or an error in the path between the tank system and the second point of release is established if one or several of the following criteria are satisfied:
the pressure in the tank system drops;
a change of a mixture composition in an exhaust gas system is established;
a changed turning moment or a changed rotational speed of the combustion engine is established; and
a reaction of an idle regulator of the combustion engine is established.

10. A method according to claim 1, further comprising producing an initial low pressure in a tank, preferably via an electric pump, and in that after the buildup of the low pressure, a second tank ventilation valve is opened and the path between the tank system and a second point of release is recognized as functional, regarding a flow rate, if the pressure increases in the tank.

11. A method according to any one of claims 1, wherein an operating point, such that the pressure in a tank is higher than an inlet manifold pressure, is used for checking the functionality of a lambda deviation in an exhaust gas.

12. A method according to claim 11, wherein a first point of release is recognized as functional if, at an opened first tank ventilation valve, a change of an air ratio lambda occurs towards a rich status or a lean status.

13. A method according to claim 11, wherein a second point of release is recognized as functional if, at an opened first tank ventilation valve, a change of an air ratio lambda occurs towards a rich status and after opening a second tank ventilation valve the air ratio lambda changes towards a stoichiometric mixture.

14. A method according to claim 1, wherein the pressure that occurs in the tank system is determined by use of a pressure sensor.

15. A method according to claim 1, wherein the pressure in the tank system can be implied from an electric current and/or a rotational speed of a pump.

16. A method according to claim 15, wherein the pump is controlled in status such that the pressure in the tank system corresponds with an ambit pressure and a plurality of operating factors of the pump, preferably an electric amperage and the rotational speed, are acquired for calibrating the pump.

17. A device, especially a customized controller, to diagnose a tank system of a vehicle having a plurality of controllable tank ventilation valves with at least two points of release for a tank ventilation mixture, whereby at least one point of release leads to a suction tube of a combustion engine positioned downstream of a throttle device and at least one point of release is arranged in a suction tube of the combustion engine positioned upstream of the throttle device, the at least one point of release positioned upstream of the throttle device positioned especially upstream of a compressor, the device comprising: controlling the at least two tank ventilation valves, wherein the at least two tank ventilation valves are independently controlled; and
deriving the functionality of a tank ventilation system, wherein the functionality is implied from a pressure that occurs in the tank system.

18. A computer program, which executes all steps if it runs in a computer, of instructions for diagnosing a tank system of a vehicle having a plurality of controllable tank ventilation valves with at least two points of release for a tank ventilation mixture, whereby at least one point of release leads to a suction tube of a combustion engine positioned downstream of a throttle device and at least one point of release is arranged in a suction tube of the combustion engine positioned upstream of the throttle device, the at least one point of release positioned upstream of the throttle device positioned especially upstream of a compressor, the computer program including instructions for: controlling the at least two tank ventilation valves, wherein the at least two tank ventilation valves are independently controlled; and deriving the functionality of a tank ventilation system, wherein the functionality is implied from a pressure that occurs in the tank system.

19. A computer program product with a program code stored on a machine-readable carrier to implement, if executed on a computer or a customized controller, a method for diagnosing a tank system of a vehicle having a plurality of controllable tank ventilation valves with at least two points of release for a tank ventilation mixture, whereby at least one point of release leads to a suction tube of a combustion engine positioned downstream of a throttle device and at least one point of release is arranged in a suction tube of the combustion engine positioned upstream of the throttle device, the at least one point of release positioned upstream of the throttle device positioned especially upstream of a compressor, the method comprising: controlling the at least two tank ventilation valves, wherein the at least two tank ventilation valves are independently controlled; and deriving the functionality of a tank ventilation system, wherein the functionality is implied from a pressure that occurs in the tank system.
